(19) United States
(12) Patent Application Publication
(10) Pub. No.: US 2008/0255886 A1
(43) Pub. Date: Oct. 16, 2008

(54) System and Method of Confirming a Transaction Between Parties

(75) Inventors: W. Andrew Unkefer, Phoenix, AZ (US); Gregg E. Griffin, Surprise, AZ (US); Chad P. Hilkemeier, Glendale, AZ (US); Susan E. Hauge, Phoenix, AZ (US)

Correspondence Address: QUARLES & BRADY LLP, RENAISSANCE ONE, TWO NORTH CENTRAL AVENUE, PHOENIX, AZ, 85004-2391, US

(73) Assignee: CONFIRMATIONCALL.COM, Glendale, AZ (US)

(21) Appl. No.: 11/735,232

(22) Filed: Apr. 13, 2007

(51) Int. Cl. G06Q 40/00

(52) U.S. Cl. 705/4; 705/78

(57) ABSTRACT

A service confirmation system records a disclosure of a transaction between first and second parties. The disclosure is confirmed for accuracy and sufficiency and then stored in a computer system. The confirmation can be retrieved to review the disclosure of the transaction. The confirmation is made by a third party to the transaction and includes voice as well as video data. The voice data can be analyzed for accuracy. The disclosure includes elements of suitability of the transaction for benefit of the second party. The disclosure covers areas such as start date, cost, fees, benefits, cancellation, and other topics material to the transaction. The elements of suitability involve income, financial obligations, assets, health, family, insurance coverage, and personal goals. The recording reveals subjective confirmation factors such as sufficiency of disclosure, suitability assessment criteria, basis for purchase decision, demeanor of the parties, environment, representations, tone, party actions, and purchase reasoning.

### FIELD OF THE INVENTION

The present invention relates in general to business services and, more particularly, to a system and method of documenting the intent and understanding as well as confirming accuracy and sufficiency of disclosure in a commercial transaction between parties.

### BACKGROUND OF THE INVENTION

Service providers work every day to apply their trade to their customer base. Service providers have many different specialties, including insurance, investments, legal contracts, and real estate. In the case of the insurance industry, the agent works to provide the right policy and coverage from the insurance company to the customer. Insurance companies typically provide a wide range of programs and policies. Due to the complexity and importance of its products, the insurance company uses agents to sell from the available programs. The insurance often covers critical assets of the customer, e.g., life, home, automobile, health, and retirement, and must provide the proper coverage under the circumstances. It is the agent's job, working on behalf of the insurance company, to investigate and understand the needs of the client and then offer the most appropriate and suitable insurance coverage for that customer.

Each agent operates at the pleasure of the insurance company and, in many cases, is licensed by the state. The agent becomes authorized to sell policies on behalf of a specific insurance company once he or she is so designated by the same company. The agent receives a commission on each policy sale. Although the agent operates independent of the insurance company, he or she remains responsible for acting in the best interests of the company as well as the customer.

In rendering service, the insurance agent meets with the customer and explains the various policies and programs offered by the insurance company(s) that he or she is representing. The agent also inquires into the customer's financial situation and goals to identify the proper policy and program that is suitable under the circumstances. For example, the agent may explain the benefits of an annuity over other retirement programs. The customer receives the information and decides whether to purchase the product. The agent must make full disclosure of the policy's features, limitations, and costs. In most cases, face-to-face communication is advisable to answer all questions, provide full disclosure of benefits, explain limitations and costs, and generally ensure suitability of the policy for the customer's personal situation. Once the customer understands and agrees with a particular insurance program, the agent completes the necessary forms and the insurance coverage begins.

At some time later, questions may be raised by the customer concerning the policy and the agent's actions during the sales process. The customer may claim that the agent failed to make full disclosure, or that the policy was not suitable under the circumstances. The customer may claim that the agent failed to disclose certain charges, renewals, credits, benefit limitations, and other relevant technical provisions. The customer may demand that the insurance company cancel the policy or make restitution. Needless to say, the insurance company takes the customer's complaint seriously, conducts an investigation, and acts accordingly. However, in most such investigations, many of the facts are difficult to reconstruct with any level of confidence. There is no complete record of the entire content of the discussions between the agent and customer nor any indication of the presentation environment or demeanor of the parties. Other than the printed disclosure forms and maybe some notes from the agent, the investigator may be left with two different versions of the events surrounding the transaction. To distinguish a bad sale from what was a legitimate sale that the customer now wants to void is difficult. If the insurance company investigator finds in favor of the customer, the company likely loses any profit from the sale and the agent likely loses his or her commission.

In an attempt to rectify customers' claims of failure to disclose and misrepresentation, the insurance companies have developed a myriad of disclosure forms, typically very lengthy and thorough, but written in legalese and fine print. In many cases, the disclosure forms have become self-defeating as the information contained therein is too dense and technical for any layperson to understand. The disclosure forms may function in legal theory, but in practice have limited value in conveying understandable information to the customer. Moreover, disclosure forms cannot by themselves confirm the suitability of the policy for the customer's needs and objectives. Preprinted disclosure forms cannot evaluate and confirm individual financial situations and goals. Since the customer defines suitability with the assistance of the agent, it is difficult to capture in forms what was right for the customer at the time of purchase of the insurance program. The nature of the interaction between the parties is also missing from the forms. The forms show nothing of the atmosphere or pressure during the presentation, or assurances or representations that may have been made. The task of reconstructing the totality of the discussions between the agent and customer, sometimes years after the fact, is most difficult. The recall dilemma can be compounded with the elderly, who often are the customers for such insurance policies.

The same problem can be found in many other industries. In the investment world, the customer may complain, after the fact, that a salesperson misrepresented an investment. The purchaser of an automobile may claim that certain options were promised but not delivered. Two parties to a real estate contract may disagree about their respective promises and intent.

### SUMMARY OF THE INVENTION

A need exists to document the intent and understanding as well as confirming accuracy and sufficiency of disclosure in a commercial transaction between parties.

Accordingly, in one embodiment, the present invention is a computer-implemented method of confirming a transaction offered by a first party to a second party comprising the steps of disclosing the transaction between the first and second parties, wherein the disclosure includes elements of suitability of the transaction for benefit of the second party, recording elements of the disclosure of the transaction to confirm accuracy and sufficiency of the disclosure, storing the recording, and retrieving the recording to review the disclosure of the transaction.

In another embodiment, the present invention is a computer-implemented method of confirming a transaction comprising the steps of disclosing the transaction between first and second parties, wherein the disclosure includes elements of suitability of the transaction for benefit of the second party, confirming accuracy and sufficiency of the disclosure of the transaction, storing a confirmation of the disclosure, and retrieving the confirmation to review the accuracy and sufficiency of the disclosure of the transaction.

In another embodiment, the present invention is a computer-implemented method of confirming a transaction comprising the steps of disclosing the transaction between first and second parties, wherein the disclosure includes elements of suitability of the transaction for benefit of the second party, recording a confirmation of the disclosure, storing the recording of the confirmation, and retrieving the recording of the confirmation.

In another embodiment, the present invention is a computer program product usable with a programmable computer processor having a computer readable program code embodied therein comprising computer readable program code which provides for disclosing a transaction between first and second parties, wherein the disclosure includes elements of suitability of the transaction for benefit of the second party, records a confirmation of the disclosure, stores the recording of the confirmation, and retrieves the recording of the confirmation.

In another embodiment, the present invention is a computer system for confirming a transaction comprising means for disclosing the transaction between first and second parties, wherein the disclosure includes elements of suitability of the transaction for benefit of the second party, means for recording a confirmation of the disclosure, means for storing the recording of the confirmation, and means for retrieving the recording of the confirmation.

### BRIEF DESCRIPTION OF THE DRAWINGS

FIG. 1 is a block diagram of a service confirmation system;

FIG. 2 is a disclosure checklist for use with the service confirmation system;

FIGS. 3a-3c illustrate a suitability form for use with the service confirmation system;

FIG. 4 is a flowchart of the steps involved in the service confirmation system; and

FIG. 5 is a computer network for executing the method of confirming a transaction.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

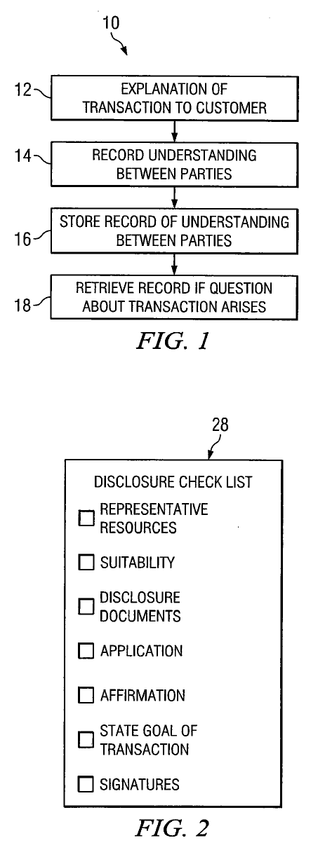

A service confirmation system 10 is shown in FIG. 1. In general, the service confirmation system 10 involves a first party (salesperson) disclosing details of a transaction to a second party (customer). The first party records, or has recorded by a third party confirmation system, the understanding, intent, disclosure, and interaction between the parties. The recorded disclosure provides an objective and independent confirmation of the details of the disclosure, subjects covered, representations made, transaction environment, and demeanor of the parties.

The present service confirmation system can be used in many different types of service providers and commercial transactions. For example, the service confirmation system can be used in the insurance industry where the salesperson explains the insurance policy to the customer, answers the customer's questions, and, if the customer accepts the terms and conditions of the policy, completes the transaction. The system is also applicable to investments, contract negotiations, real estate transactions, automobile purchases, and any other commercial transaction where it is helpful to document and record the exchange, understanding, and intent between the parties.

In block 12 of FIG. 1, the service provider explains the details of the transaction to the customer. In block 14, the understanding between the parties is recorded. The recording process may occur during the entire conversation between the parties, or it may be made at the conclusion of the transaction to summarize the understandings of the parties. In block 16, the record is stored for later access. In block 18, the record is retrieved and reviewed if a question or issue arises as to the transaction itself, the content of the disclosure, or the understanding between the parties.

For the purpose of explanation, the service confirmation system is described in terms of an insurance transaction. Due to the complexity and importance of its products, the insurance company uses agents to sell from its portfolio of available programs. An agent (service provider) may approach a potential customer to offer insurance coverage. The agent may have a wide range of programs and policies from one or more insurance companies, e.g., tax-deferred annuity, immediate annuity, life insurance, wealth transfer, and estate planning, just to name a few. The insurance often covers critical assets of the customer, e.g., life, home, automobile, health, and retirement, and must be proper and appropriate under the circumstances. The agent works to provide the right policy and coverage from the insurance company to the customer. It is the agent's job, working on behalf of the insurance company, to understand and evaluate the needs of the client and then offer the most appropriate and suitable insurance coverage for that customer.

The insurance agent typically meets with the customer to explain the various policies, programs, costs, and benefits offered by the insurance company(s) that he or she is representing. For example, the agent may discuss the benefits of an annuity over other retirement programs. In most cases, face-to-face communication is advisable to answer all questions, explain all benefits, limitations and costs, and generally ensure the suitability of the policy for the customer's personal situation. The agent inquires into the customer's financial situation and goals to identify the proper policy and program that is suitable under the circumstances. The agent may ask questions about the customer's occupation, income, financial obligations, credit history, retirement plans, assets, health, family, present insurance coverage, and personal goals. The customer listens to the presentation, asks questions, and decides whether to purchase the product.

During the presentation, the agent must make full disclosure of the policy features, limitations, and costs. The disclosure may involve an explanation of when the policy starts, cost of the policy, administrative fees, when and how benefits are paid out, change of beneficiary, cancellation policy, situations not covered in policy, death or disablement of policy holder, survivor benefits, etc. In addition, the agent conducts due diligence as to the suitability of the policy being considered for this particular customer. In view of the customer's overall profile, the question is asked as to whether the policy under consideration is a suitable product to meet his or her needs and goals. The suitability standard is defined by the customer but must be reviewed and acknowledged by both the agent and customer.

In service confirmation system 10, the disclosure and suitability are reviewed and acknowledged in a manner that is well-documented and reproducible at a later date. In one embodiment, the disclosure and suitability review and acknowledgement are recorded. The record must show the content of the disclosure, suitability assessment criteria, basis for the customer's decision, demeanor of the agent and customer, environment, representations, tone, actions, reasoning, and other subjective confirmation factors that are relevant to the fairness, accuracy, and thoroughness of the session. The record can be made with the use of forms, voice recording, video recording, and other media and devices that can document the events and interaction between the agent and customer. The record can be made for the entire presentation or in summary after a policy has been selected by the customer.

The record of the transaction is made through service confirmation system 10. The system operates independent of the agent and the insurance company to provide an accurate and objective record of the transaction. A third party confirmation service provider maintains and operates the system. The third party confirmation service uses computer systems and recording devices to create the record. In one embodiment, the record is maintained as computer voice and video files stored on the computer system. The system may be fully automated. Alternatively, a human representative may be made available when necessary to assist with the recording process and to answer questions.

In another embodiment, the recording is made by the agent using local equipment, e.g., voice recorder, camcorder, laptop computer, or other electronic recording device. At the appropriate time, the agent activates the local equipment to record the disclosure and document the understanding between the parties. The local equipment records the understanding and interaction between the parties in total or in summary. The locally-made recording is then electronically transmitted or physically transferred to the third party confirmation service provider for storage and archiving. The local computer generates the necessary forms, makes the recording, executes a digital signature, and provides a copy to customer.

Consider an example where the agent has presented and the customer has decided to purchase an annuity program. The agent informs the customer that for accuracy and thoroughness and generally to provide better customer service, it is necessary to review and confirm important aspects of the transaction. The recording is made for quality assurance and customer protection purposes. The agent calls the service confirmation system 10 by telephone or other electronic communication device. The phone number can be toll-free and dedicated to a particular insurance company. The agent is connected to service confirmation system 10 in an automated mode or is placed in contact with a human representative of the third party service provider. The agent receives an introductory message from the system and initiates a setup for the service confirmation. The setup involves collecting certain basic information as to the insurance company involved and nature of the call. When the agent is ready to begin recording, he or she notifies the representative or simply presses a predetermined number on the telephone keypad. The service confirmation system proceeds to activate the recording process.

Once the agent confirms that the recording device is operating, he or she proceeds to review and confirm the transaction in the presence of the customer. In one embodiment, the review and confirmation process involves only a summary of the transaction, including identification of the parties, overview of the discussions to date, evaluation of suitability of the transaction under the circumstances, and intent and understanding of the parties in completing the transaction. The service confirmation system records only a portion of the total interaction between the parties, i.e., a summary of transaction. Alternatively, the service confirmation system can record the entirety of the transaction from the time the agent arrives to the time the agent leaves.

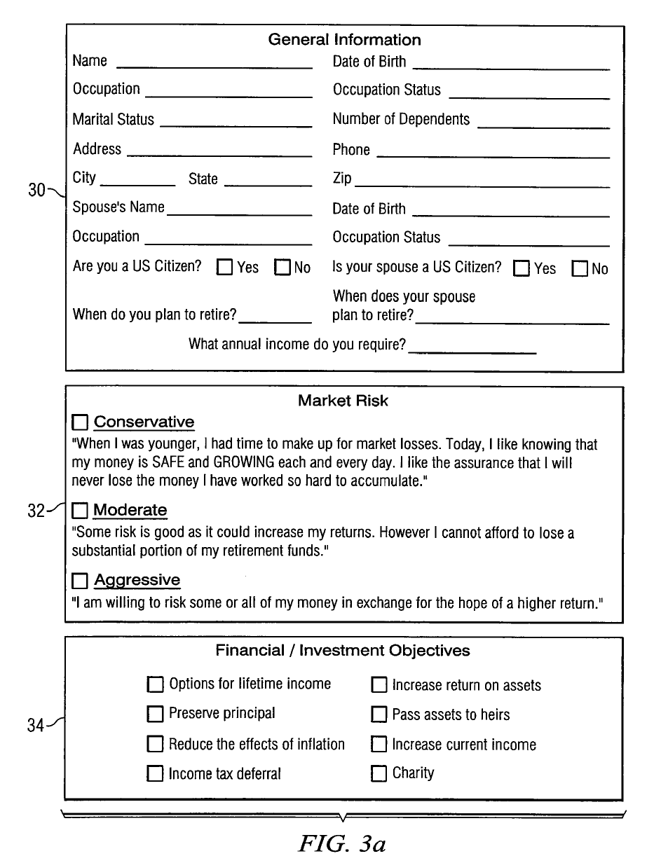

FIG. 2 is a disclosure checklist 28 for the agent to utilize the recording features of the service confirmation system. The disclosure checklist 28 contains the steps that the agent must follow in utilizing the service confirmation system. In a first step, the disclosure checklist 28 has a checkbox for representative resources. To complete the representative resources step, the agent identifies himself or herself and the customer, e.g., “I am insurance agent John Smith representing Mutual Insurance Company. I am here today with Mr. Bill Jones residing at (home address). We have been discussing an annuity program available through Mutual Insurance Company.” The agent goes on to identify parties present, date, time, and location of the presentation. The agent further notes any relevant circumstances or background information, e.g., the presentation is being conducted at the office of the customer's business advisor at the request of the customer.

The disclosure checklist 28 also has a checkbox for suitability. In the suitability review, the agent reviews all information collected from the customer that is relevant to a recommendation for a specific product. The suitability review should set forth the customer's considerations and reasoning that lead to acceptance of the agent's proposal.

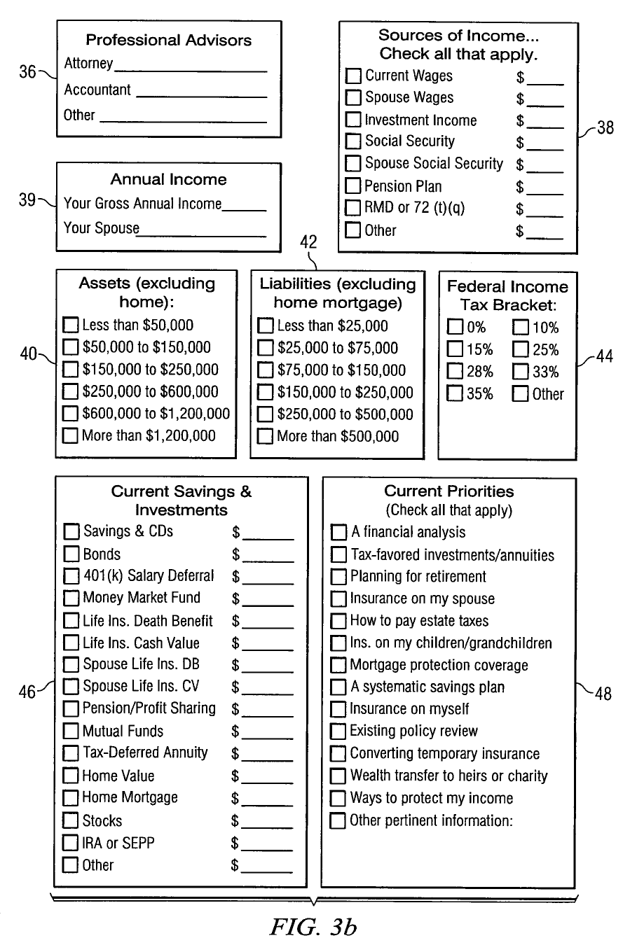

In FIGS. 3a-3c, a suitability evaluation and financial profile is shown which is used to aid the agent in reviewing the appropriateness of the program for the customer. The elements of suitability in FIGS. 3a-3c are useful in performing the due diligence needed to ascertain the customer's needs and goals. In block 30 of FIG. 3a, the customer provides general information such as name, date of birth, occupation, marital status, number of dependents, address, phone, spouse, citizenship, and retirement plans. In block 32, the customer takes into account market risk tolerance, i.e., conservative, moderate, and aggressive. Each market risk category includes characteristics of that persona to help the customer decide which designation is appropriate. In block 34, the customer considers financial and investment objectives such as options for lifetime income, preservation of capital, reducing effects of inflation, income tax deferral, increasing return on assets, passing assets to heirs, increasing current income, and charitable giving.

In block 36 of FIG. 3b, the customer can designate professional advisors such as attorney and accountant. In block 38, the customer identifies sources of income including wages, investment income, social security, pension plan, and required minimum distribution (RMD). In block 39, the customer states current annual income. In block 40, the customer provides total value of assets. In block 42, the customer provides statement of liabilities. In block 44, the customer notes his or her federal income tax bracket. In block 46, the customer values current savings and investments including savings, bonds, 401(k), money market funds, life insurance death benefits, life insurance cash value, pension, profit sharing, mutual funds, tax-deferred annuities, home value, home mortgage, stocks, and IRAs. In block 48, the customer identifies current objectives and priorities including financial analysis, tax-favored investments and annuities, planning for retirement, insurance, paying estate taxes, mortgage protection coverage, savings plan, wealth transfer, and protecting income.

In block 50 of FIG. 3c, the customer can note future plans which may include a new home, change job, lose weight, stop smoking, pay off loans, start business, bonus, salary, marriage, children, savings, retirement, inheritance, and sell assets. In block 52, a business owner considers a business continuation plan, executive bonus plan, buy and sell plan, group insurance, key employees, business overhead expense protection, qualified pension plan, business loan insurance, non-qualified retirement plan, payroll savings plan, and disability income. In block 54, the customer reviews other information such as estate planning, charity, changes in income, foreseeable expenses, and management of financial matters. Other elements of suitability are credit history, health, family, present insurance coverage, personal goals, and general notes. The notes can expand upon details of any block in FIGS. 3a-3c. In the suitability due diligence, the agent may focus on any one or combination of the above identified areas and make notes accordingly. For example, the agent may note the customer's present stock portfolio diversification, or the customer's future plans to build a new home, or the customer's concern about wealth transfer. The customer signs the suitability form in block 56.

The elements of suitability including personal information, finances, risk tolerance, plans, goals, objectives, and priorities allow the agent to evaluate the suitability of the product for the customer's needs and goals. The agent can read from portions of the suitability form during the recording session with the service confirmation system.

Returning to FIG. 2, the disclosure checklist 28 further has a checkbox for material disclosure documents, which may be required by the insurance company. Each insurance company may have its own customized forms. The agent provides the name of the product and cover all elements of the disclosure including costs and fees associated with the product, costs and fees associated with accessing customer funds, penalty for withdrawal, income provisions, interest rates, policy start date, benefit provisions, change of beneficiary, cancellation, death of policy holder, survivor benefits, surrender charges, and other benefits and limitations that may affect the customer. The agent covers at least the material portions of the disclosure forms during the recording session with the service confirmation system.

Other types of disclosure documents include a replacement form which is used to transfer an existing annuity to another company. A tax form is used for certain qualified monies, e.g., individual retirement account (IRA), which necessarily involves reference to and discussion about the tax consequences. An anti-money laundering form is used to comply with government regulations.

For the application checkbox in FIG. 2, the customer completes an insurance-company-specific application which serves to document the transaction. The application contains information such as name, address, title of the annuity, ownership, beneficiary, and tax identification number.

The affirmation checkbox in disclosure checklist 28 gives the agent the opportunity to thank the customer and confirm essential aspects of the transaction. The agent reminds the customer of important elements of the transaction, affirms the suitability of the selected program in accordance with the customer's needs and goals, and confirms the customer's acceptance and comfort level with the transaction. The agent offers to answer any final questions. If the customer has questions, then the agent answers such questions until the customer has no more questions. In some cases, the agent may not be able to answer a question, particularly if the question deals with an area outside the agent's authority or expertise. For example, the agent may not be licensed to discuss other financial instruments or provide legal advice.

In the checkbox for stating the goal of the transaction, the agent may verbally state “My goal today was to make a recommendation that was suitable for you based on your personal situation. Do you believe we have accomplished this goal today?” It is desirable to have the customer overtly and unconditionally agree with the affirmation and goal statement. An important part of the service confirmation system is to ascertain and document the reasoning for the customer's decision to purchase the policy. The agent may remind the customer that they talked about tax deferral and that was a fundamental reason why the customer believes the program is suitable. The customer may be adverse to market risk, wants money to grow safely and steadily, and that priority lead the agent to recommend a particular program. Again, the above affirmation is recorded with the service confirmation system. The affirmation is the final check that the program being purchased meets the customer's personal situation and goals. If the customer answers in the affirmative, then the suitability, disclosure, affirmation and statement of goal of the transaction are complete. The service confirmation system has provided a forum and format to confirm the accuracy and integrity of the transaction and sufficiency of the disclosure, including consideration of suitability. The system provides quality assurance and protection for the customer, agent, and insurance company alike.

The signature checkbox in disclosure checklist 28 allows for the standard practice of securing the customer's legal signature. The customer's signature finalizes the disclosure of the transaction and authorizes the purchase of the product.

Once the service confirmation and associated recording is complete, the third party confirmation service provider assigns a confirmation number. The confirmation number uniquely identifies the recording. The recording is stored or archived by the third party confirmation service in its computer system as voice data files and video data files. A copy of the recording can be given to the customer for his or her records, either in electronic form or by automatic transcription to printed document using voice recognition features of the system. The recording is retrievable by confirmation number as well as a combination of other identifying attributes such as customer name, agent name, insurance company, and date of transaction.

If a question should arise as to the accuracy and sufficiency of the disclosure, including confirmation of suitability, the recording of the transaction is a valuable information source. The recording provides not only the content of the disclosure but also subjective confirmation factors such as suitability assessment criteria, basis for purchase decision, demeanor of the first and second parties, environment, representations, tone, voice inflection, party actions, and purchase reasoning. The voice data reveals much about the parties' intent and meaning. In the case of video recordings, the visual recording illustrates body language, which conveys a significant amount of subjective information.

Assume some time later that the customer questions the transaction or the agent's actions during the sales process. The customer may claim that the agent failed to make full disclosure, or that the policy was not suitable under the circumstances. The customer may claim that the agent failed to disclose certain charges, renewals, credits, benefit limitations, and other relevant technical provisions. It is desirable to resolve issues when they arise with the most complete and accurate information.

In such a situation, the recording of the transaction is retrieved from the storage or archive and reviewed for its content by an investigator. The recording provides a valuable record of what actually transpired, including the demeanor of the agent and customer, the intent of the parties, and the content of the discussion. The recording often leads to a swift and fair resolution to the dispute.

The insurance company may want to review recordings as a quality check before any particular problem arises. The recording files can be downloaded to the insurance company where the compliance officer will have easy and convenient access to review the sales transactions. The insurance company can monitor, search, and report on one or more agents for quality assurance. If a problem is detected, e.g., inappropriate sales pressure, then the issue can be resolved prior to a customer complaint and hopefully avoid questionable transactions from occurring in the first place. The recorded transactions can be used for quality surveys to show levels of customer satisfaction.

In another embodiment, the voice data files can be analyzed for accuracy. Using voice recognition techniques, the voice data files can recognize and interpret the words and voice levels for content and intent. If either party is being inconsistent or inaccurate, the system can flag the transaction as suspect and decline to assign a confirmation number to complete the transaction. Consider an example where the volume of the agent's voice rises, even though the words are reasonable, and the stress level of the customer's response increases. The voice analysis may reveal that the agent is unduly pressuring the customer. In a video example, the recording may show the agent using body language to convey an undeniable “no” to a question while the agent's words state an affirmative response. The recording may show the agent standing over the customer in an intimidating manner that would not otherwise be known or appreciated. The recording can provide significant and relevant information as to the demeanor, intent, and understanding between the parties, which is useful in later evaluation of any dispute involving the transaction. The recording equipment can be even more sophisticated in monitoring human vital signs, e.g., blood pressure, heart rate, and nerve impulses, for truthfulness and subjective intent. The high-tech recording equipment can establish proof of identity of the customer by retina scan or fingerprint.

The service confirmation system 10 can also be used for real-time confirmation. Instead of reviewing previously made recordings after the fact, the system can be set up to confirm the transaction as it occurs. Using the voice recognition capability discussed above, the system can monitor the agent and customer for key words and answers to material questions. Each required key word and answer constitutes a disclosure gateway that must be traversed before the system will complete the transaction and assign a confirmation number. Failure to meet all disclosure gateways invalidates the confirmation. For example, the agent may go through the disclosure checklist 28 of FIG. 2, which the service confirmation system acknowledges at each step via the voice recognition feature. The system monitors statements of disclosure, e.g., costs and benefits of policy. The system looks for financial information. The system will require affirmative answers from the customer to key questions. Once the checklist is complete, and the agent and customer pass through each disclosure gateway, the system generates the confirmation number. No voice or video recording is generated but the confirmation exists by nature of the system having validated a plurality of disclosure gateways which collectively confirm the accuracy and sufficiency of the disclosure. In other words, the confirmation resides in the structure of the service confirmation program code in that the confirmation number would not have been generated but for successful validation of each of the disclosure gateways. The same capability can be provided with human representatives from the third party confirmation service provider. The representative will ask the question, confirm the disclosure gateways, and generate the confirmation number. The representative acts as an objective facilitator to ensure the accuracy and sufficiency of the disclosure of the transaction. If the agent did not say what he or she was supposed to say, and if the required disclosure topics were not covered in total, and if the customer did not respond affirmatively to all affirmations, such as described in FIGS. 2 and 3a-3c, then the system would not provide the confirmation number to complete the transaction.

As mentioned above, the service confirmation system can be used to validate and confirm other types of transactions. In one embodiment, two or more parties to a contract will have a record made of each party's intent and understanding to the agreement. If a dispute arises, e.g., one party is alleged to have made certain representations which are now denied or viewed differently, the recording serves as a valuable source of information to resolve the issues between the parties. Other commercial transactions that can be well-served by the service confirmation system include real estate, automobile purchases, and brokerage services.

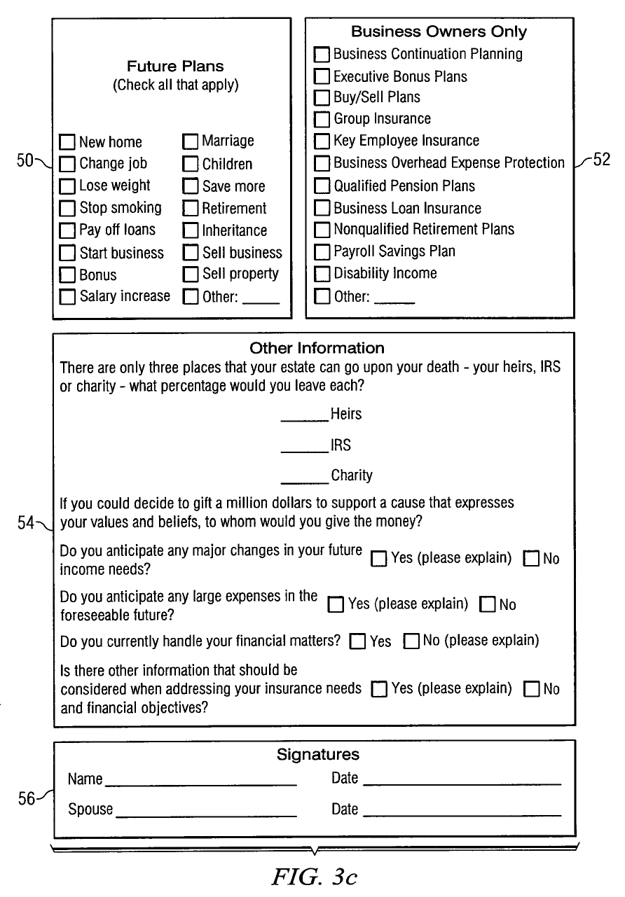

As further explanation, FIG. 4 illustrates a process flowchart of one embodiment of the computer-implemented method of confirming a transaction offered by a first party to a second party. The transaction may involve an insurance policy. In step 70, the transaction between the first and second parties is disclosed to a third party confirmation service. In the case of an insurance transaction, the elements of the disclosure may include start date, cost, fees, interest rate, benefit provisions, change of beneficiary, cancellation, death of policy holder, survivor benefits, and surrender charges. The disclosure includes elements of suitability of the transaction for benefit of the second party. In the insurance transaction, the elements of suitability of the transaction for the second party are occupation, income, financial obligations, credit history, retirement plans, assets, health, family, present insurance coverage, and personal goals. In step 72, the elements of the disclosure and suitability of the transaction are recorded to confirm accuracy and sufficiency of the disclosure. The recording can have voice data and video data which contain subjective confirmation factors. The recorded subjective confirmation factors include content of the disclosure, suitability assessment criteria, basis for purchase decision, demeanor of the first and second parties, environment, representations, tone, party actions, and purchase reasoning. The voice data is analyzed for accuracy. The confirmation can be made by validating a plurality of disclosure gateways which collectively attest to the accuracy and sufficiency of the disclosure. In step 74, the recording is stored in a computer system by a confirmation number. In step 76, the recording is retrieved to review the disclosure of the transaction. The ability to review the accuracy and sufficiency of the disclosure by retrieving the subjective confirmation factors enhance quality assurance and provide protection for all parties concerned.

Service confirmation system 10 is a computer-based communication network with electronic links between parts of the system. Each of the communication links described herein can be direct hard-wired lines, leased high-bandwidth lines, telephone lines, fiber optic cable, wireless, satellite, or the like. The electronic communication links provide the medium to record and confirm the commercial transactions.

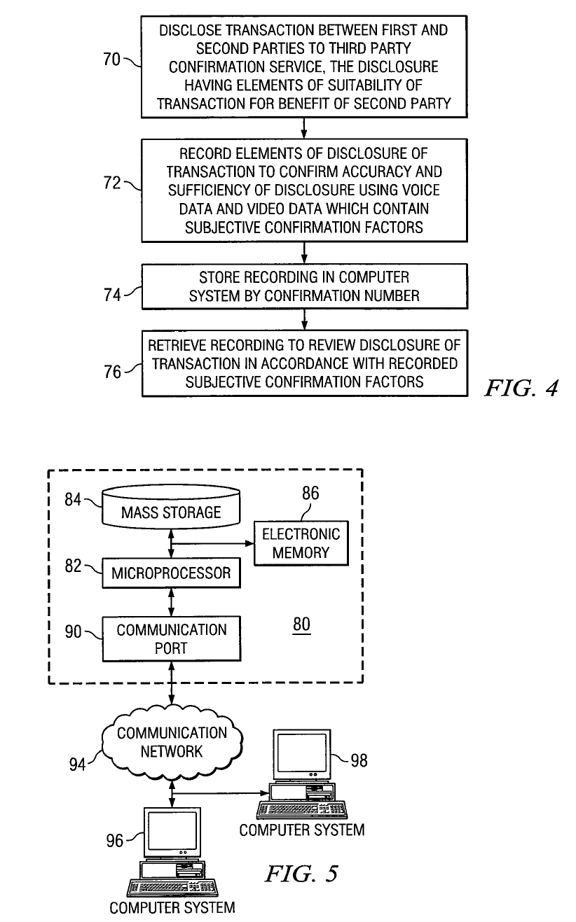

FIG. 5 illustrates a simplified computer system 80 for executing the software program used in the service confirmation system. Computer system 80 is a general purpose computer including a central processing unit or microprocessor 82, mass storage device or hard disk 84, electronic memory 86, and communication port 90. Communication port 90 represents a modem, high-speed Ethernet link, or other electronic connection to transmit and receive input/output (I/O) data with respect to other computer systems.

Computer 80 is shown connected to communication network 92 by way of communication port 90, which in turn is connected to server 94. Server 94 operates as a system controller and includes mass storage devices, operating system, and communication links for interfacing with communication network 92. Communication network 92 can be a local and secure communication network such as an Ethernet network, global secure network, or open architecture such as the Internet. Computer systems 96 and 98 can be configured as shown for computer 80 or dedicated and secure data terminals. Computers 96 and 98 are also connected to communication network 92. Computers 80, 96, and 98 transmit and receive information and data over communication network 92.

When used as a standalone unit, computer 80 can be located in any convenient location. When used as part of a computer network, computers 80, 96, and 98 can be physically located in any location with access to a modem or communication link to network 92. For example, computer 80 can be located in the main office of the third party confirmation service provider. Computer 96 can be located in the agent's office. Computer 98 can be located in the insurance company office. Alternatively, the computers can be mobile and follow the users to any convenient location, e.g., remote offices, customer locations, hotel rooms, residences, vehicles, public places, or other locales with electronic access to communication network 92.

Each of the computers runs application software and computer programs, which can be used to display user interface screens, execute the functionality, and provide the features of the service confirmation system as described above. In one embodiment, the screens and functionality come from the application software, i.e., the service confirmation system runs directly on one of the computer systems. Alternatively, the screens and functions are provided remotely from one or more websites on the Internet. In this case, the local computer is a portal to the service confirmation system running on a remote computer. The websites have generally restricted access and require passwords or other authorization for accessibility. Communications through the website may be encrypted using secure encryption algorithms. Alternatively, the screens are accessible only on the secure private network, such as Virtual Private Network (VPN), with proper authorization.

The software is originally provided on computer readable media, such as compact disks (CDs), magnetic tape, or other mass storage medium. Alternatively, the software is downloaded from electronic links such as the host or vendor website. The software is installed onto the computer system hard drive 84 and/or electronic memory 86, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. In the case of Internet-based websites, the interface screens are implemented as one or more webpages for receiving, viewing, and transmitting information related to the service confirmation system. A host service provider may set up and administer the website from computer 80 or server 94 located in the host service provider's home office. The employee accesses the webpages from computers 96 and 98 via communication network 92. The software contains one or more programming modules, subroutines, computer links, and compilations of executable code which perform the functions of the service confirmation system. The user interacts with the software via keyboard, mouse, voice recognition, and other user interface devices connected to the computer system.

The software stores the recordings and other information and data related to the service confirmation system in a database or file structure located on any one of, or combination of, hard drives 84 of the computers 80, 96, 98, and/or server 94. More generally, the information used in the service confirmation system can be stored on any mass storage device accessible to computers 80, 96, 98, and/or server 94. The mass storage device for storing the service confirmation system may be part of a distributed computer system.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of confirming a transaction offered by a first party to a second party, comprising:
disclosing the transaction between the first and second parties, wherein the disclosure includes elements of suitability of the transaction for benefit of the second party;
recording elements of the disclosure of the transaction to confirm accuracy and sufficiency of the disclosure, the recording including subjective confirmation factors;
storing the recording; and
retrieving the recording to review the disclosure of the transaction.

2. The computer-implemented method of claim 1, wherein the recording is made by a third party to the transaction.

3. The computer-implemented method of claim 1, wherein the recording includes voice data.

4. The computer-implemented method of claim 3, further including analyzing the voice data for accuracy.

5. The computer-implemented method of claim 1, wherein the recording includes video data.

6. The computer-implemented method of claim 1, further including storing the recording by a confirmation number.

7. The computer-implemented method of claim 1, wherein the transaction involves an insurance policy.

8. The computer-implemented method of claim 1, wherein the elements of suitability of the transaction for the second party are selected from the group consisting of occupation, income, financial obligations, credit history, retirement plans, assets, health, family, present insurance coverage, and personal goals.

9. The computer-implemented method of claim 1, wherein the elements of the disclosure of the transaction are selected from the group consisting of start date, cost, fees, interest rate, benefit provisions, change of beneficiary, cancellation, death of policy holder, survivor benefits, and surrender charges.

10. The computer-implemented method of claim 1, wherein the recording includes subjective confirmation factors selected from the group consisting of content of the disclosure, suitability assessment criteria, basis for purchase decision, demeanor of the first and second parties, environment, representations, tone, party actions, and purchase reasoning.

11. A computer-implemented method of confirming a transaction, comprising:
disclosing the transaction between first and second parties, wherein the disclosure includes elements of suitability of the transaction for benefit of the second party;
confirming accuracy and sufficiency of the disclosure of the transaction;
storing a confirmation of the disclosure; and
retrieving the confirmation to review the accuracy and sufficiency of the disclosure of the transaction.

12. The computer-implemented method of claim 11, wherein the confirmation is made by a third party to the transaction.

13. The computer-implemented method of claim 11, further including validating a plurality of disclosure gateways which collectively confirm the accuracy and sufficiency of the disclosure.

14. The computer-implemented method of claim 11, wherein the confirmation of the disclosure includes making a recording of elements of the disclosure of the transaction.

15. The computer-implemented method of claim 14, wherein the recording includes voice data.

16. The computer-implemented method of claim 15, further including analyzing the voice data for accuracy.

17. The computer-implemented method of claim 14, wherein the recording includes video data.

18. The computer-implemented method of claim 11, wherein the elements of suitability of the transaction for the second party are selected from the group consisting of occupation, income, financial obligations, credit history, retirement plans, assets, health, family, present insurance coverage, and personal goals.

19. The computer-implemented method of claim 11, wherein the elements of the disclosure of the transaction are selected from the group consisting of start date, cost, fees, interest rate, benefit provisions, change of beneficiary, cancellation, death of policy holder, survivor benefits, and surrender charges.

20. The computer-implemented method of claim 11, wherein the recording includes subjective confirmation factors selected from the group consisting of content of the disclosure, suitability assessment criteria, basis for purchase decision, demeanor of the first and second parties, environment, representations, tone, party actions, and purchase reasoning.

21. A computer-implemented method of confirming a transaction, comprising:
disclosing the transaction between first and second parties, wherein the disclosure includes elements of suitability of the transaction for benefit of the second party;
recording a confirmation of the disclosure;
storing the recording of the confirmation; and
retrieving the recording of the confirmation.

22. The computer-implemented method of claim 21, wherein the confirmation is made by a third party to the transaction.

23. The computer-implemented method of claim 21, wherein the recording includes voice data.

24. The computer-implemented method of claim 23, further including analyzing the voice data for accuracy.

25. The computer-implemented method of claim 21, further including validating a plurality of disclosure gateways which collectively confirm the accuracy and sufficiency of the disclosure.

26. The computer-implemented method of claim 21, wherein the elements of suitability of the transaction for the second party are selected from the group consisting of occupation, income, financial obligations, credit history, retirement plans, assets, health, family, present insurance coverage, and personal goals.

27. The computer-implemented method of claim 21, wherein the recording includes subjective confirmation factors selected from the group consisting of content of the disclosure, suitability assessment criteria, basis for purchase decision, demeanor of the first and second parties, environment, representations, tone, party actions, and purchase reasoning.

28. A computer program product usable with a programmable computer processor having a computer readable program code embodied therein, comprising:
computer readable program code which provides for disclosing a transaction between first and second parties, wherein the disclosure includes elements of suitability of the transaction for benefit of the second party;
computer readable program code which records a confirmation of the disclosure;
computer readable program code which stores the recording of the confirmation; and
computer readable program code which retrieves the recording of the confirmation.

29. The computer program product of claim 28, wherein the confirmation is made by a third party to the transaction.

30. The computer program product of claim 28, wherein the recording includes voice data.

31. A computer system for confirming a transaction, comprising:
means for disclosing the transaction between first and second parties, wherein the disclosure includes elements of suitability of the transaction for benefit of the second party;
means for recording a confirmation of the disclosure;
means for storing the recording of the confirmation; and
means for retrieving the recording of the confirmation.

32. The computer system of claim 31, wherein the recording includes voice data.

33. The computer system of claim 31, wherein the confirmation is made by a third party to the transaction.
